(19) United States
(12) Patent Application Publication
(10) Pub. No.: US 2018/0095792 A1
(43) Pub. Date: Apr. 5, 2018

(54) MULTI-CORE SYSTEM INCLUDING HETEROGENEOUS PROCESSOR CORES WITH DIFFERENT INSTRUCTION SET ARCHITECTURES

(71) Applicant: MEDIATEK INC., Hsin-Chu (TW)

(72) Inventor: Tzu-Hsiang Chien, Taoyuan City (TW)

(21) Appl. No.: 15/653,544

(22) Filed: Jul. 19, 2017

Related U.S. Application Data
(60) Provisional application No. 62/404,745, filed on Oct. 5, 2016.

(51) Int. Cl. G06F 9/48

(52) U.S. Cl. CPC G06F 9/4893; G06F 2209/483

(57) ABSTRACT

A multi-core system includes a plurality of heterogeneous processor cores with different/distinct instruction set architectures, a task scheduler, and a processor manager. The processor cores are connected to a high speed bus different from a peripheral bus. The task scheduler is coupled to the processor cores and configured for dispatching at least one task to the heterogeneous processor cores. The processor manager is coupled to the processor cores and the task scheduler, and is configured for managing the heterogeneous processor cores according to information gathered from the task scheduler.

### CROSS REFERENCE TO RELATED APPLICATIONS

This application claims priority of U.S. provisional application Ser. No. 62/404,745 filed on Oct. 5, 2016, which is entirely incorporated herein by reference.

### BACKGROUND

Generally speaking, a conventional multi-core processor system includes multi-types of processor cores implemented with the same instruction set architecture(s) (ISA(s)). For example, if the conventional multi-core processor system needs to be with more than two kinds of ISAs, each processor core of the conventional system is implemented with the same full-set ISA. For example, all the conventional processor cores may be implemented with the same full-set ISA supporting both 32-bit tasks and 64-bit tasks so that the processor cores can be arranged to run the 32-bit tasks and 64-bit tasks.

Further, 32-bit tasks may be 32/16-bit mixed tasks. For example, processor cores of a conventional multi-core processor system may be implemented with the same full-set ISA such as A32-ISA supporting pure 32-bit tasks, T32-ISA supporting pure 16-bit tasks and special 16/32-bit mixed tasks, and A64-ISA supporting pure 64-bit tasks.

However, to implement all the processor cores with the same full-set ISA supporting both 32-bit tasks and 64-bit tasks, it necessarily adds more hardware circuits which occupy more die areas, wastes more power, and slows down the overall performance/design. Some conventional multi-core processor system may be designed to include processor cores implemented with the same full-set ISA supporting only 64-bit tasks and with binary translators for translating 32-bit ISA into 64-bit ISA for execution of 32-bit tasks. This scheme, however, has poor compatibility, low execution speed, and consumes more power.

### SUMMARY

Therefore one of the objectives of the invention is to provide a multi-core system, an apparatus running the multi-core system, and a corresponding method, to solve the above-mentioned problems.

According to the embodiments of the invention, a multi-core system includes a plurality of heterogeneous processor cores with different/distinct instruction set architectures, a task scheduler, and a processor manager. The processor cores are connected to a high speed bus different from a peripheral bus. The task scheduler is coupled to the processor cores and configured for dispatching at least one task to the heterogeneous processor cores. The processor manager is coupled to the processor cores and the task scheduler, and is configured for managing the heterogeneous processor cores according to information gathered from the task scheduler.

According to the embodiments, the apparatus running a multi-core system includes a multi-core processor, a task scheduler, and a processor manager. The multi-core processor includes a plurality of processor cores with different/distinct instruction set architectures, and the processor cores comprise at least one first processor core with at least one first instruction set architecture and at least one second processor core with at least one second instruction set architecture different from the first instruction set architecture. The task scheduler is coupled to the multi-core processor and configured for dispatching at least one task to the plurality of processor cores. The processor manager is coupled to the multi-core processor and the task scheduler, and is configured for managing the plurality of processor cores according to information gathered from the task scheduler.

According to the embodiments, the method for running a multi-core system on the apparatus comprises: providing and utilizing a multi-core processor including a plurality of processor cores with different/distinct instruction set architectures, the processor cores comprising at least one first processor core with at least one first instruction set architecture and at least one second processor core with at least one second instruction set architecture different from the first instruction set architecture; dispatching at least one task from a task queue to the plurality of processor cores; and, managing the plurality of processor cores according to information gathered from the task queue.

According to the embodiments, more power can be saved, and it is not needed to use many hardware circuits for implementations and thus does not occupy more die areas. In addition, the overall performance/design will not be slowed down, and the compatibility is improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a computer architecture diagram of an apparatus running a multi-core system according to a first embodiment of the invention.

FIG. 2 is a simplified diagram of a second embodiment of the multi-core processor as shown in FIG. 1.

FIG. 3 is a simplified diagram of a third embodiment of the multi-core processor as shown in FIG. 1.

FIG. 4 is a simplified diagram of a fourth embodiment of the multi-core processor as shown in FIG. 1.

FIG. 5 is a simplified diagram of a fifth embodiment of the multi-core processor as shown in FIG. 1.

FIG. 6 is a diagram of an example of the 32-bit kernel space delegating a 64-bit kernel task to a 64-bit kernel space.

FIG. 7 is a diagram illustrating an example of a 32-bit and 64-bit hybrid operating system.

FIG. 8 is a diagram illustrating the relation between the microcontroller (or the sensor hub RTOS) and the 64-bit operating system.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The invention is to aim at provide an apparatus running a multi-core system including heterogeneous processor cores implemented with different/distinct instruction set architectures (ISAs), and a corresponding method and/or the multi-core system. All modifications of the multi-core system including heterogeneous processor cores implemented with different/distinct ISAs should fall within the scope of the invention. Processor cores with different/distinct ISAs mean at least two processor cores with at least two different/distinct ISAs such as a combination of processor core(s) with N-bit ISA and 2N-bit ISA while other processor core(s) with only 2N-bit ISA (but not limited), a combination of processor core(s) with only N-bit ISA while other processor core(s) with only 2N-bit ISA, or a combination of three group of processor core(s) respectively with only N-bit ISA, only 2N-bit ISA, and both N-bit ISA and 2N-bit ISA; N means an integer such as 16, 32, 64, 128, or other integer. In the following embodiments, an example of value N is 32 but is not meant to be a limitation. In addition, some processor core(s) may be implemented with (N/2)-bit ISA.

It should be noted that the number of processor cores, the processor core types, or other configurations are not meant to be limitations of the invention. The heterogeneous processor cores mean two or more different processor core types such as a fast processor core and a power efficient processor core (but not limited) wherein the different processor core types have different performances and power consumption characteristics. The apparatus running the multi-core system can be implemented as an integrated circuit chip included within a portable electronic device such as a mobile phone.

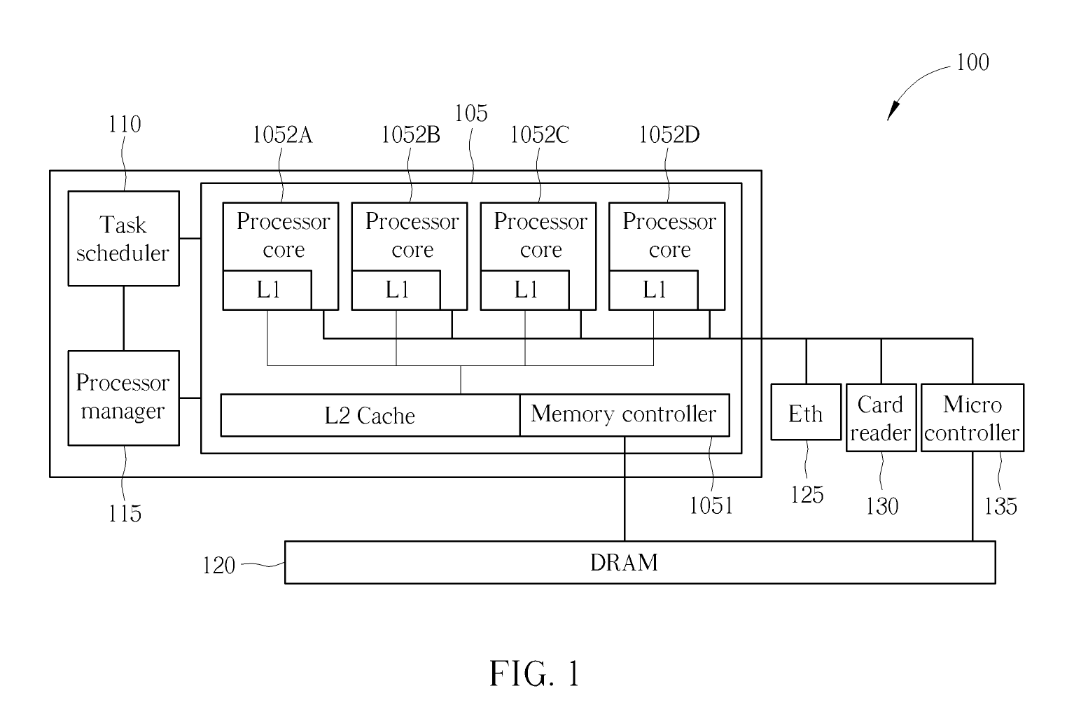

Refer to FIG. 1, which is a computer architecture diagram of an apparatus 100 running a multi-core system according to a first embodiment of the invention. The apparatus 100 comprises a multi-core processor 105 including a plurality of processor cores such as four processor cores 1052A-1052D, a task scheduler 110, and a processor manager 115. The apparatus 100 implemented as a system-on-chip (SoC) circuit (but not limited) is externally coupled to a memory device such as DRAM 120 via a memory controller 1051 of the multi-core processor 105, and is also externally connected to at least peripheral device such as an Ethernet device 125, a card reader 130, and/or a microcontroller 135 via an peripheral bus specified by a data bus architecture such as Advanced Microcontroller Bus Architecture (AMBA). The microcontroller 135 can access the DRAM 120 via direct memory access (DMA) interface.

The task scheduler 110 is coupled to the multi-core processor 105 and arranged to dispatch at least one task from a task queue (not shown in FIG. 1) to the processor cores 1052A-1052D wherein the at least one task comprises N-bit task(s) and/or 2N-bit task(s) (but not limited); the at least one task may comprises (N/2)-bit subset tasks. For example, the task scheduler 110 can be arranged to dispatch the at least one task to the processor cores 1052A-1052D by referring to at least one information of an instruction set architecture compatibility of the at least one task, a priority of tasks pending in the task queue, and/or the characteristics of the processor cores 1052A-1052D.

The processor manager 115 is coupled to the multi-core processor 105 and task scheduler 110, and is arranged to turn on/off the processor cores 1052A-1052D. For example, the processor manager 115 can be arranged to turn on/off the processor cores 1052A-1052D according to the information gathered from the task scheduler 110 and/or the information from the processor cores 1052A-1052D. The operations and implementations of task scheduler 110 and processor manager 115 are illustrated later.

The processor cores 1052A-1052D are heterogeneous processor cores and can be classified as at least one first processor core and at least one second processor core. For example, in the embodiment, the processor cores 1052A-1052D are configured as a quad-core circuit and comprise two first processor cores such as cores 1052A&1052B and two second processor cores such as cores 1052C&1052D wherein the processor cores 1052A and 1052B are implemented with a high speed processor core (i.e. a fast processor core) while the processor cores 1052C and 1052D are implemented by a low speed processor core without consuming more power (i.e. a power efficient processor core). However, this is not meant to be a limitation. In another example, the processor cores 1052A and 1052B may be low speed processor cores and the processor cores 1052C and 1052D may be high speed processor cores. In addition, the numbers of first processor cores and second processor cores are not limited; for instance, the quad-core circuit may comprise a single one first processor core and three second processor cores or may comprise a single one power efficient processor core and three fast processor cores.

In addition, the total number of processor cores is not meant to be a limitation of the invention. In other embodiment, the multi-core processor 105 may be designed with eight processor cores or ten processor cores. In addition, the definition of each processor core means an independent unit that reads and executes instructions such as add, move data, and branch. Each processor core includes L1 cache connected to a shared L2 cache via a high speed data bus different from the peripheral bus. The high speed data bus can be implemented with a cache bus or a memory bus.

The two first processor cores 1052A and 1052B are implemented with at least one first ISA and the two second processor cores 1052C and 1052D are implemented with at least one second ISA different from the at least one first ISA. For example, the at least one first ISA including/supporting N-bit ISA and 2N-bit ISA respectively compatible with N-bit and 2N-bit tasks, and the at least one second ISA including/supporting 2N-bit ISA only for 2N-bit tasks. For instance, the at least one first ISA is compatible with 32-bit and 64-bit tasks, and the at least one second ISA is compatible with only 64-bit tasks.

In addition, in other embodiment, the at least one first ISA may only support N-bit ISA for N-bit tasks, and the at least one second ISA supports only 2N-bit ISA for 2N-bit tasks. Alternatively, one of the first processor cores 1052A and 1052B may support both N-bit ISA and 2N-bit ISA respectively for N-bit and 2N-bit tasks, and the other of the first processor cores 1052A and 1052B may support only 2N-bit ISA for 2N-bit tasks; one of the second processor cores 1052C and 1052D may support both N-bit ISA and 2N-bit ISA respectively for N-bit and 2N-bit tasks, and the other of the second processor cores 1052C and 1052D may support only 2N-bit ISA for 2N-bit tasks. All the modifications fall within the scope of the invention.

Moreover, the above-mentioned processor cores may be implemented by different processor core structures/types or combinations thereof, such as cluster structure, non-cluster structure, flexible cluster micro-architecture, power efficient processor core, fast processor cores, or other structures/types.

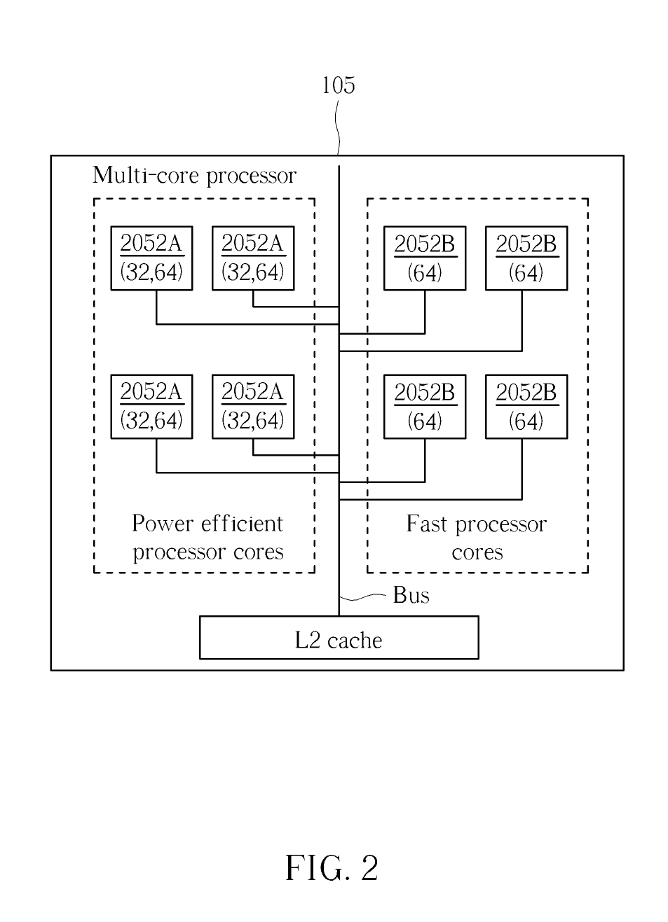

The number of heterogeneous processor cores implemented with different ISAs is not limited. FIG. 2 is a simplified diagram of a second embodiment of the multi-core processor 105 as shown in FIG. 1. The multi-core processor 105 for example comprises eight processor cores consisting of four power efficient processor cores 2052A and four fast processor cores 2052B. The power efficient processor cores 2052A are implemented with both N-bit ISA and 2N-bit ISA which are compatible with N-bit and 2N-bit tasks such as 32-bit and 64-bit tasks. The fast processor cores 2052B are implemented with only 2N-bit ISA compatible with 2N-bit tasks such as 64-bit tasks. Each processor core also includes L1 cache (not shown in FIG. 2) connected to a shared L2 cache via a high speed data bus different from the peripheral bus. The high speed data bus can be implemented with a cache bus or a memory bus.

In addition, in one embodiment, the four processor cores 2052A can be grouped as a cluster, and the four processor cores 2052B can be grouped as a different cluster; however, this is not meant to be a limitation. The fast processor cores 2052B is compatible with only 64-bit tasks/instructions, and the processor manager 115 of FIG. 1 is arranged to turn on at least one of four fast processor cores 2052A to run 32-bit task(s) when the task scheduler 110 dispatches the 32-bit task(s). Compared to the prior art, if it is determined that no 32-bit tasks are pending in the task queue, the processor manager 115 can be arranged to disable or turn off all the power efficient processor cores 2052A to save power as far as possible. In addition, it needs less die area to implement the processor cores with only the 64-bit ISA, the processor cores with only the 64-bit ISA consume less power and can run faster.

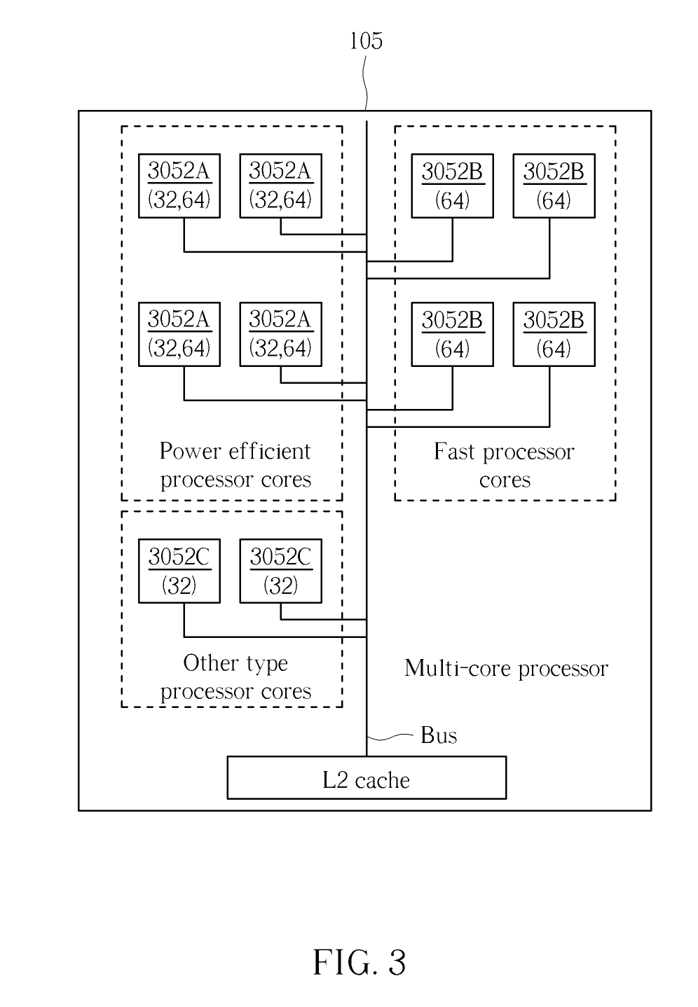

The heterogeneous processor cores can be implemented by at least three different types of processor cores. FIG. 3 is a simplified diagram of a third embodiment of the multi-core processor 105 as shown in FIG. 1. The multi-core processor 105 for example comprises ten processor cores consisting of four power efficient processor cores 3052A, four fast processor cores 3052B, and two other type processor cores 3052C. The power efficient processor cores 3052A are implemented with both N-bit ISA and 2N-bit ISA which are compatible with N-bit and 2N-bit tasks such as 32-bit and 64-bit tasks. The fast processor cores 3052B are implemented with only 2N-bit ISA which is compatible with 2N-bit tasks such as 64-bit tasks. The two other type processor cores 3052C are implemented with a third ISA (N-bit ISA) which is compatible with exactly only N-bit tasks such as 32-bit tasks. Each processor core includes L1 cache (not shown in FIG. 3) connected to a shared L2 cache via a high speed data bus different from the peripheral bus. The high speed data bus can be implemented with a cache bus or a memory bus.

In addition, in one embodiment, the four processor cores 3052A can be grouped as a cluster, and the four processor cores 3052B can be grouped as a different cluster; the other type processor cores 3052C are grouped as a third cluster. However, this is not meant to be a limitation. The task scheduler 110 can preferentially assign 32-bit task(s) to the processor cores 3052C which are equivalently processor cores dedicated to run the 32-bit task(s). The processor manager 115 can turn on at least one of the power efficient processor cores 3052A and turn off the fast processor cores 3052B, and the task scheduler 110 assigns specific task(s) to the at least one turned-on power efficient process core, if running the specific task(s) does not need to consume more computation resources or more power. The processor manager 115 can turn on at least one of the fast processor cores 3052B and the task scheduler 110 assigns specific task(s) to the at least one turned-on fast process core if running the specific task(s) needs to consume more computation resources or more power.

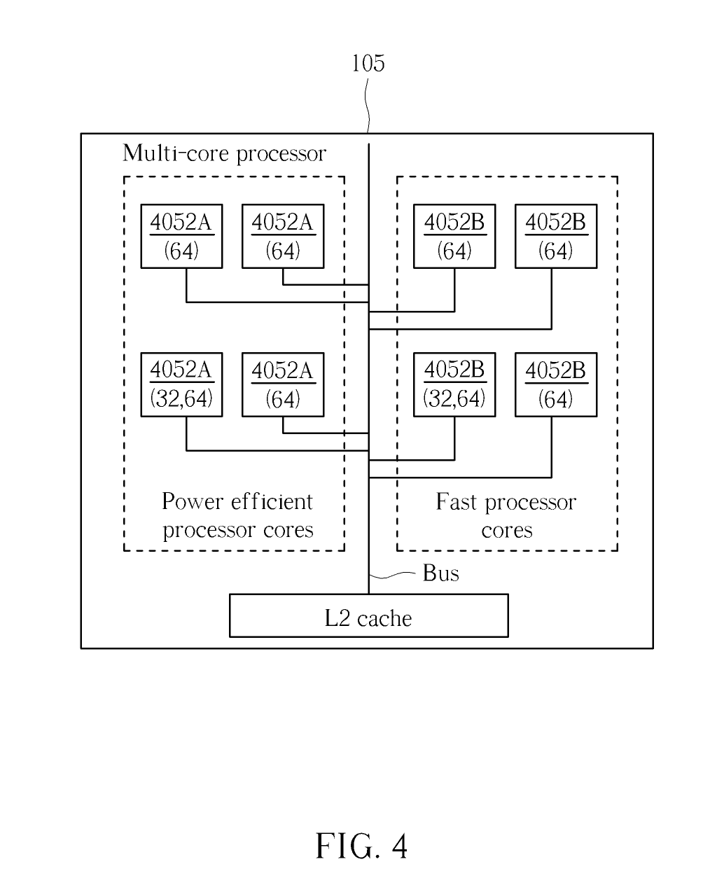

Further, in one embodiment, a portion of the same type processor cores and another portion of the processor cores can be respectively implemented with different ISAs. FIG. 4 is a simplified diagram of a fourth embodiment of the multi-core processor 105 as shown in FIG. 1. The multi-core processor 105 for example comprises eight processor cores consisting of four power efficient processor cores 4052A and four fast processor cores 4052B. One of the power efficient processor cores 4052A are implemented with both N-bit ISA and 2N-bit ISA which are compatible with N-bit and 2N-bit tasks such as 32-bit and 64-bit tasks while other power efficient processor cores are implemented with only 2N-bit ISA which is compatible with 2N-bit tasks such as 64-bit tasks, as shown in FIG. 4. Similarly, one of the fast processor cores 4052B are implemented with N-bit ISA and 2N-bit ISA which are compatible with N-bit and 2N-bit tasks such as 32-bit and 64-bit tasks while other fast processor cores are implemented with 2N-bit ISA which is compatible with 2N-bit tasks such as 64-bit tasks. Most of the fast processor cores 4052B and most of the power efficient processor cores 4052A are implemented with 64-bit ISA compatible with 64-bit tasks/instructions for running 64-bit tasks. The group of power efficient processor cores 4052A and the group of fast processor cores 4052B each has one processor core implemented with 32-bit ISA and 64-bit ISA compatible with 32-bit and 64-bit tasks. One group of processor cores (the group of power efficient processor cores 4052A or the group of fast processor cores 4052B) can be turned off regardless of whether a 32-bit task is pending in the task queue or not.

In addition, each processor core includes L1 cache (not shown in FIG. 4) connected to a shared L2 cache via a high speed data bus different from the peripheral bus. The high speed data bus can be implemented with a cache bus or a memory bus. In addition, in one embodiment, the four processor cores 4052A can be grouped as a cluster, and the four processor cores 4052B can be grouped as a different cluster; however, this is not meant to be a limitation.

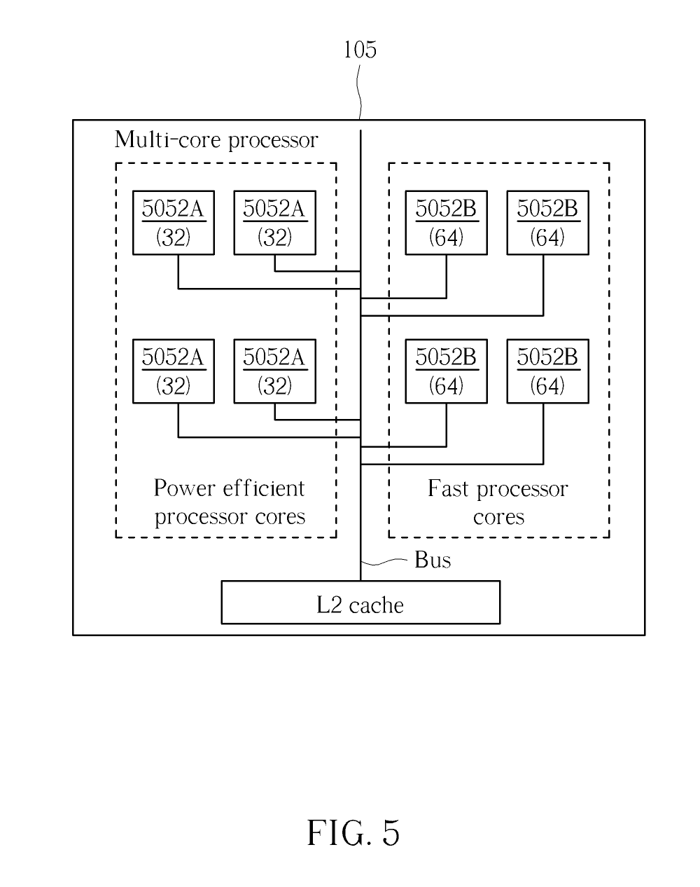

Further, in one embodiment, the heterogeneous processor cores can respectively support only N-bit ISA compatible with N-bit tasks and only 2N-bit ISA compatible with 2N-bit tasks. FIG. 5 is a simplified diagram of a fifth embodiment of the multi-core processor 105 as shown in FIG. 1. The multi-core processor 105 for example comprises eight processor cores consisting of four power efficient processor cores 5052A and four fast processor cores 5052B. For example, all the power efficient processor cores 5052A are implemented with only N-bit ISA which is compatible with only N-bit tasks such as 32-bit tasks, and all the fast processor cores 5052B are implemented with only 2N-bit ISA which is compatible with only 2N-bit tasks such as 64-bit tasks. Alternatively, all the fast processor cores 5052B can be implemented with only 32-bit ISA which compatible with only 32-bit tasks, and all the power efficient processor cores 5052A can be implemented with only 64-bit ISA which is compatible with only 64-bit tasks.

If no 32-bit tasks are pending in the task queue, the processor manager 115 can be arranged to turn off all the power efficient processor cores 5052A, and the task scheduler 110 is arranged to assign an incoming 32-bit task to the microcontroller 135 of FIG. 1 to use a corresponding host sensor hub real-time operating system (RTOS) to run the 32-bit task. This can save more power. Similarly, each processor core includes L1 cache (not shown in FIG. 5) connected to a shared L2 cache via a high speed data bus different from the peripheral bus. The high speed data bus can be implemented with a cache bus or a memory bus. In addition, in one embodiment, the four processor cores 5052A can be grouped as a cluster, and the four processor cores 5052B can be grouped as a different cluster; however, this is not meant to be a limitation.

All the above-mentioned modifications for the heterogeneous multi-core system implemented with different/distinct ISAs obey the spirit of the invention and should fall within the scope of the invention.

Examples of the operation and implementation of the task scheduler 110 are detailed in the following. The task scheduler 110 is responsible to assign tasks pending in the task queue to compatible processor cores. For example, a 32-bit task is assigned to a compatible processor core which may be implemented with only 32-bit ISA or with both 32-bit ISA and 64-bit ISA. Similarly, a 64-bit task is assigned to a compatible processor core which may be implemented with only 64-bit ISA or with both 32-bit ISA and 64-bit ISA.

For example, as shown in FIG. 4, the task scheduler 110 can be arranged to assign a 32-bit task to either the processor core 4052A with both 32-bit ISA and 64-bit ISA or the processor core 4052B with both 32-bit ISA and 64-bit ISA. The task scheduler 110 assigns a 64-bit task to a processor core with only 64-bit ISA if such processor core is available, and assigns the 64-bit task to another processor core with both 32-bit ISA and 64-bit ISA if no processor cores compatible with only 64-bit tasks are available.

Further, in one embodiment, the task scheduler 110 can be implemented in the operating system. An advantage is that the operating system can be aware of the physical configuration of the processor cores; the processor cores of FIGS. 1-5 also refer to physical processor cores. For the implementation of task scheduler 110, the operating system is arranged to maintain a list of 32-bit and 64-bit pending tasks, and picks up another compatible task from the task queue when a context switch interrupt on a processor core happens. The operating system sets up corresponding registers, updates the user space execution mode, and performs the context switch. Information of the task queue (e.g. the number of pending tasks) and the priority of list maintained by the operating system can be referenced by the processor manager 115 to control or turn on/off the physical processor cores. For instance, the task scheduler 110 can be arranged to make a request to ask the processor manager 115 to turn on the processor cores which are compatible with 32-bit tasks if 32-bit tasks are pending in the task queue; similarly, the task scheduler 110 can make a request to ask the processor manager 115 to turn on the processor cores which are compatible with 64-bit tasks if 64-bit tasks are pending in the task queue.

In addition, the task scheduler 110 can be arranged to suggest the processor manager 115 to increase 32-bit computation capabilities if a lot of 32-bit tasks are pending in the task queue; similarly, the task scheduler 110 can suggest the processor manager 115 to increase 64-bit computation capabilities if a lot of 64-bit tasks are pending in the task queue. In addition, if pending 32-bit tasks are with higher priorities, the task scheduler 110 can suggest the processor manager 115 to increase 32-bit computation capabilities; similarly, if pending 64-bit tasks are with higher priorities, the task scheduler 110 can suggest the processor manager 115 to increase 64-bit computation capabilities. In addition, if a 64-bit task requires a lock which is held by a 32-bit task, it is preferable to increase the execution speed of the 32-bit task. For increasing the execution speed, it is preferred to increase the working frequency of processor cores compatible with 32-bit tasks or to turn on more processor cores compatible with 32-bit tasks so that a blocking task has more opportunity to be scheduled.

Additionally, in another embodiment, the task scheduler 110 can be implemented as a set of hardware virtual cores. An advantage is that the set of hardware virtual cores can be placed between the operating system and the physical configuration of the processor cores so that the operating system can be agnostic about the physical configuration of the processor cores. Any kinds of the operating system are compatible with the physical configuration of the processor cores. For the hardware implementation of the task scheduler 110, the set of hardware virtual cores, represented by multiple registers or other circuits, are controlled by the operating system and are respectively mapped to the physical processor cores such as the processor cores in FIGS. 1-5. If more virtual cores are using a particular/specific ISA, the tasks from the virtual cores can be interleaved in a round robin manner and the fine-grained simultaneous multithreading (SMT) on the physical processor cores is enabled so that the each physical processor core can run two or more hardware threads. Information of the tasks assigned to the virtual cores and/or information of counter of the execution mode can be referenced by the processor manager 115 to control or turn on/off the physical processor cores.

In addition, the task scheduler 110 can be configured to prefer to assign 64-bit tasks to processor cores with only 64-bit ISA if the processor cores with both 32-bit ISA and 64-bit ISA are low speed processor cores or consume more power. Further, the task scheduler 110 can be arranged to assign 64-bit tasks to the processor cores with both 32-bit ISA and 64-bit ISA even when the processor cores with both 32-bit ISA and 64-bit ISA are fully utilized. For example, it may be preferable to disable the processor cores with only 64-bit ISA when some 32-bit tasks are running and the whole system is in a low power mode.

For the processor manager 115, its responsibility is to manage the processor cores of FIGS. 1-5 and tune the characteristics of the processor cores. For example, the processor manager 115 can be arranged to turn on/off the processor cores (e.g. power gating), suspend/pause/resume the processor cores (e.g. clock gating), increase/decrease the working frequencies of the processor cores, and/or change/adjust other characteristics of the processor cores based on the information gathered from the task scheduler 110 and/or the information of characteristics of the processor cores. The processor manager 115 can be implemented in the operating system or implemented as a firmware, which can decide to manage the characteristics of the processor cores based on the information form the task scheduler 110. Alternatively, the processor manager 115 can be implemented as a hardware circuit which can decide to manage the characteristics of the processor cores based on the processor cores' utilization rates, performance counters, ISA usage counters, and/or virtual core distribution. The processor manager 115 can be arranged to alter the characteristics of a single processor core and/or alter a cluster of processor cores if multiple processor cores are grouped as a cluster.

In other embodiments, the above-mentioned processor cores with only 2N-bit ISA supporting 2N-bit tasks such as 64-bit tasks can be further implemented with a binary translation unit for converting 32-bit instructions or 32/16-bit mixed instructions to 64-bit instructions if such ISA is not supported by the hardware natively.

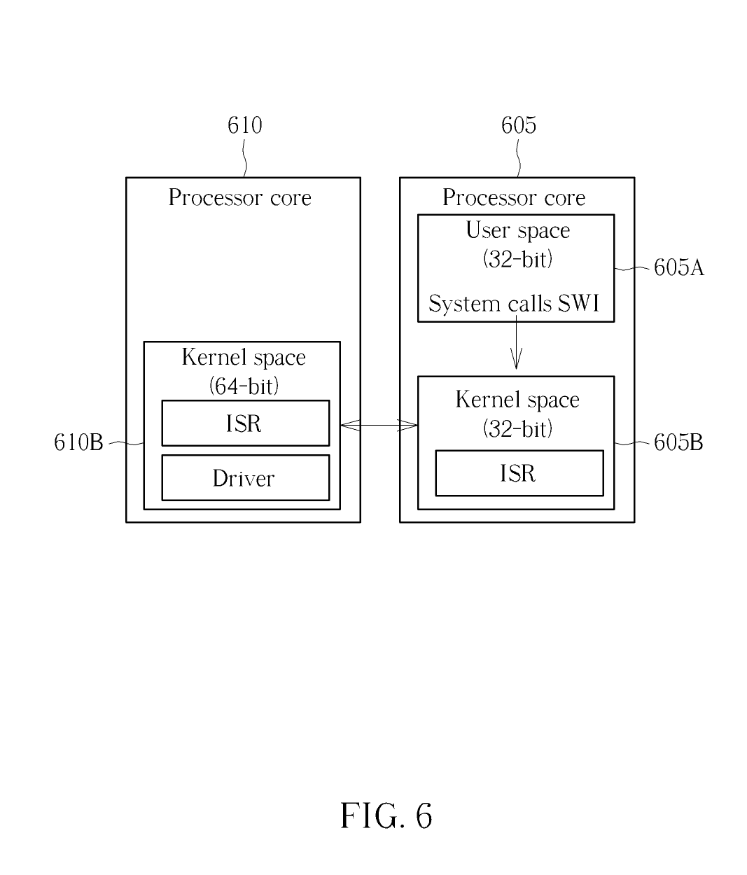

Further, if the kernel space of a processor core is implemented as 32-bit kernel space and cannot run a 64-bit kernel task, the operating system can register another set of interrupt service routines (ISRs), which can delegate the 64-bit kernel task to another processor core with 64-bit kernel space and pick up another compatible task from the task queue to service. FIG. 6 is a diagram of an example of the 32-bit kernel space delegating a 64-bit kernel task to a 64-bit kernel space. The processor core 605 includes 32-bit user space process 605A and 32-bit kernel space 605B. When the 64-bit task is incoming and a system call occurs to trigger a software interrupt (SWI) to the 32-bit kernel space 605B, the 32-bit kernel space 605B is arranged to register a quick ISR and/or a delegator to delegate the kernel task of the 64-bit task to the 64-bit kernel space 610B of another processor core 610 which employs corresponding ISR and driver to execute the 64-bit kernel task and returns the result back to the 32-bit kernel task 605B. It is not needed for the task scheduler 110 to reassign the 64-bit kernel task to a 64-bit kernel space.

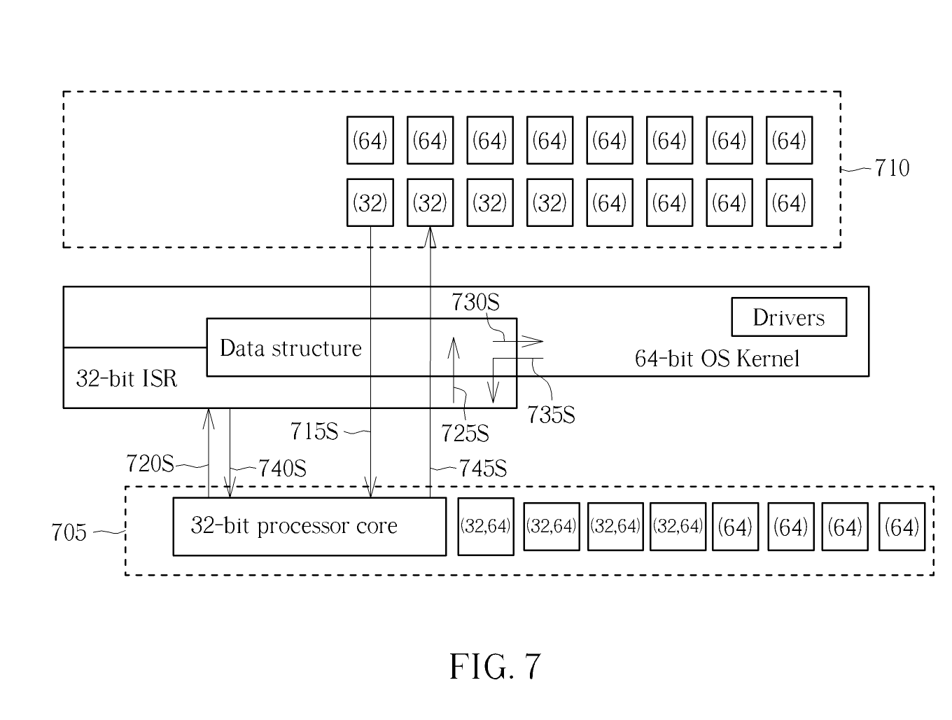

FIG. 7 is a diagram illustrating an example of a 32-bit and 64-bit hybrid operating system. 705 means the processor cores which comprise a 32-bit processor core, four processor cores supporting both 32-bit and 64-bit tasks, and four processor cores supporting only 64-bit tasks. 710 means the tasks pending in the queue and comprises 32-bit tasks and 64-bit tasks. The operating system includes the 64-bit kernel space, and drivers are compiled into 64-bit binaries. The processor core with 32-bit kernel space is arranged to delegate the system calls or interrupts to the 64-bit kernel space of the operating system and meanwhile the processor core with 32-bit kernel space can pick up another task from the task queue if such system call is a blocking system call. For example, in Step 715S, the 32-bit processor core processes a 32-bit task from the task queue, and registers a 32-bit ISR in Step 720S. In Step 725S, the 32-bit ISR generates a corresponding data structure in the random access memory (RAM) for the 64-bit kernel space of the operating system. In Step 730S, the 64-bit kernel space is arranged to activate corresponding driers to process this task based on the data structure and return a corresponding data structure after activating the drivers in Step 735S. If the 64-bit kernel space has not return the corresponding data structure after activating the drivers, the 32-bit ISR is arranged to inform the 32-bit kernel space of this event in Step 7405, and the 32-bit kernel space is arranged to pause the task which requests the 64-bit kernel space to execute or process, and then is arranged to execute context switch and pick up another 32-bit task from the task queue to execute or process in Step 745S. It should be noted that the data structure may refer to a waiting queue, a message/command passing queue, I/O buffer, and so on; this is not a limitation of the invention.

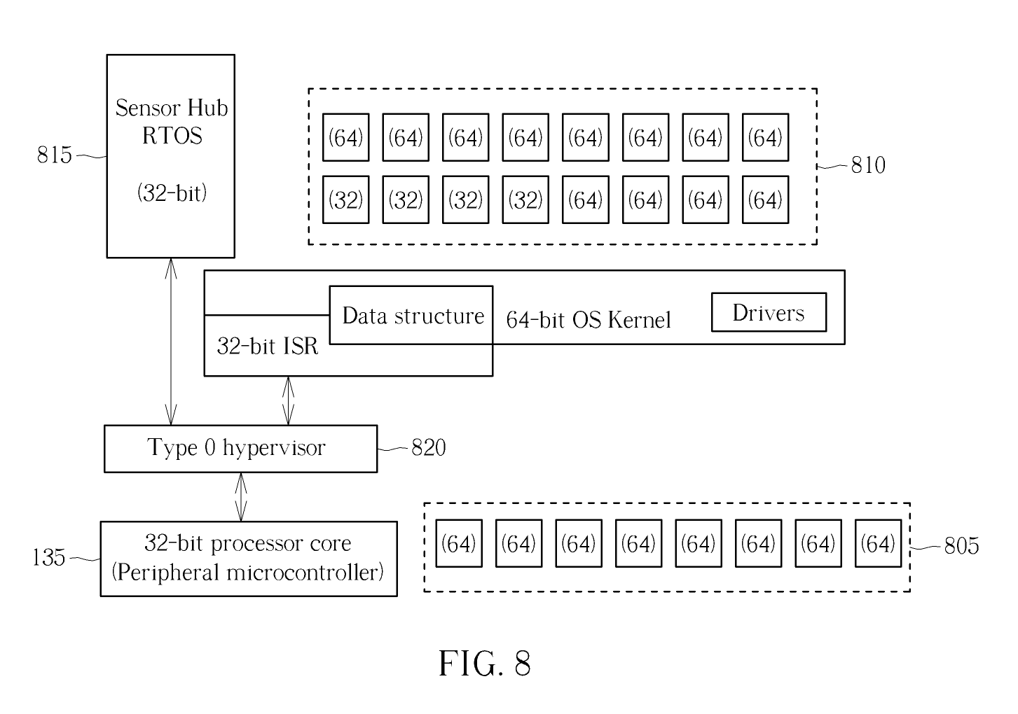

Further, in other embodiment, a peripheral microcontroller including a processor core with 32-bit ISA, e.g. the microcontroller 135, can be employed as a processor core for executing the 32-bit task if the physical processor cores included within the multi-core processor 105 are merely with 64-bit ISA. In addition, the sensor hub RTOS with a smaller independent operating system can be employed as a processor core for executing the 32-bit task. This can be achieved by using a hypervisor as an intermediate interface circuit between the microcontroller 135 (or the sensor hub RTOS) and the 64-bit operating system. FIG. 8 is a diagram illustrating the relation between the microcontroller 135 (or the sensor hub RTOS) and the 64-bit operating system. 810 means the tasks pending in the queue and comprises 32-bit tasks and 64-bit tasks. 805 means the processor cores which comprise 64-bit processor cores. The type 0 hypervisor 820 is configured as an intermediate interface circuit between the microcontroller 135 and the 64-bit kernel space of the operating system or between the sensor hub RTOS 815 and the 64-bit kernel space of the operating system.

Further, for the embodiments as shown in FIGS. 1-5, if some of the physical processor cores included within the multi-core processor are implemented with 32-bit ISA compatible with 32-bit tasks, the microcontroller 135 (or the sensor hub RTOS) can be disabled or turned off in some situations to save power, and task(s) originally executed by the microcontroller 135 (or the sensor hub RTOS) can be transferred by the hypervisor to the physical processor cores for execution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus running a multi-core system, comprising:
a multi-core processor including a plurality of processor cores with different/distinct instruction set architectures, the processor cores comprising at least one first processor core with at least one first instruction set architecture and at least one second processor core with at least one second instruction set architecture different from the at least one first instruction set architecture;
a task scheduler, coupled to the multi-core processor, configured for dispatching at least one task to the plurality of processor cores; and
a processor manager, coupled to the multi-core processor and the task scheduler, configured for managing the plurality of processor cores according to information gathered from the task scheduler.

2. The apparatus of claim 1, wherein the at least one first processor core and the at least one second processor core correspond to different core types associated with different hardware characteristics, respectively, or correspond to a same core type; and, the at least one first instruction set architecture comprises instruction set architectures compatible with N-bit tasks, (N/2)-bit subset tasks, and 2N-bit tasks, and the at least one second instruction set architecture is compatible with only 2N-bit tasks; N is an integer.

3. The apparatus of claim 2, wherein the processor cores further comprises at least one third processor core implemented with a third instruction set architecture which supports only N-bit tasks.

4. The apparatus of claim 2, wherein the at least one first processor core is disabled or turned off when no N-bit tasks are pending in a task queue of the task scheduler.

5. The apparatus of claim 1, wherein the at least one first instruction set architecture comprises one instruction set architecture supporting only N-bit tasks, and the at least one second instruction set architecture comprises one instruction set architecture supporting only 2N-bit tasks; N is an integer.

6. The apparatus of claim 1, wherein the at least one first processor core and the at least one second processor core correspond to a same core type; and, the at least one first instruction set architecture comprise instruction set architectures respectively supporting N-bit tasks, (N/2)-bit subset tasks, and 2N-bit tasks, and the at least one second instruction set architecture comprises one instruction set architecture supporting only 2N-bit tasks; N is an integer.

7. The apparatus of claim 6, wherein the processor cores further comprise another set of processor cores corresponding to a different core type and support N-bit tasks and 2N-bit tasks; and the at least one first processor core and the at least one second processor core are disabled or turned off regardless of whether an N-bit task is pending in a task queue of the task scheduler.

8. The apparatus of claim 1, wherein the task scheduler is arranged to dispatch the at least one task to the plurality of processor cores by referring to at least one of: an instruction set architecture compatibility of the at least one task, a priority of tasks in a task queue of the task scheduler, and characteristics of the plurality of processor cores.

9. The apparatus of claim 1, wherein the plurality of processor cores are turned on/off according to the information gathered from the task scheduler or from the plurality of processor cores.

10. The apparatus of claim 1, wherein the at least one first processor core is implemented as a first type, and the at least one second processor core is implemented as a second type different from the first type.

11. A method for running a multi-core system on an apparatus, comprising:
providing and utilizing a multi-core processor including a plurality of processor cores with different/distinct instruction set architectures, the processor cores comprising at least one first processor core with at least one first instruction set architecture and at least one second processor core with at least one second instruction set architecture different from the at least one first instruction set architecture;
dispatching at least one task from a task queue to the plurality of processor cores; and
managing the plurality of processor cores according to information gathered from the task queue.

12. The method of claim 11, further comprising:
using the at least one first instruction set architecture including instruction set architectures to support N-bit tasks, (N/2)-bit subset tasks, and 2N-bit tasks; and
using the second instruction set architecture including one instruction set architecture to support only 2N-bit tasks; N is an integer.

13. The method of claim 12, further comprising:
using at least one third processor core implementing a third instruction set architecture which supports only N-bit tasks.

14. The method of claim 12, wherein the step of managing the processor cores comprises:
disabling or turning off the at least one first processor core when no N-bit tasks are pending in the task queue.

15. The method of claim 11, further comprising:
using the at least one first instruction set architecture including one instruction set architecture to support only N-bit tasks; and
using the at least one second instruction set architecture including one instruction set architecture to support only 2N-bit tasks; N is an integer.

16. The method of claim 11, wherein the step of dispatching the at least one task from the task queue to the plurality of processor cores comprises:
dispatching the at least one task to the plurality of processor cores by referring to at least one of: an instruction set architecture compatibility of the at least one task, a priority of tasks in the task queue, and characteristics of the plurality of processor cores.

17. The method of claim 11, wherein the step of managing the plurality of processor cores comprises:
turning on/off the plurality of processor cores according to the information gathered from the task scheduler or from the plurality of processor cores.

18. The method of claim 11, wherein the at least one first processor core is implemented as a first type, and the at least one second processor core is implemented as a second type different from the first type.

19. A multi-core system, comprising:
a plurality of heterogeneous processor cores with different/distinct instruction set architectures, the plurality of heterogeneous processor cores connected to a high speed bus different from a peripheral bus;
a task scheduler, coupled to the processor cores, configured for dispatching at least one task to the plurality of heterogeneous processor cores; and
a processor manager, coupled to the plurality of heterogeneous processor cores and the task scheduler, configured for managing the plurality of heterogeneous processor cores according to information gathered from the task scheduler.
